(19) United States
(12) Patent Application Publication
(10) Pub. No.: US 2009/0146413 A1
(43) Pub. Date: Jun. 11, 2009

(54) Method and system for joining pipeline components

(76) Inventors: Yuval Golan, New York, NY (US); Avraham Zakai, New York, NY (US)

Correspondence Address: YUVAL GOLAN, PO Box 29746, TEL AVIV, 61297, IL

(21) Appl. No.: 12/074,452

(22) Filed: Mar. 5, 2008

Related U.S. Application Data
(63) Continuation-in-part of application No. 12/001,189, filed on Dec. 11, 2007.

(51) Int. Cl. F16L 47/00

(52) U.S. Cl. 285/21.1

(57) ABSTRACT

Pipes and pipeline components made of plastic or PVC, which are designed to be assembled into pipelines used to convey water in structures, and which have one bore located on the side, near each end of the pipeline components. After assembling the pipeline in the designated wall, the pipes and pipeline components are glued together by injecting liquid acetone into the bores, causing the pipes and pipeline components to adhere to one another and to become sealed.

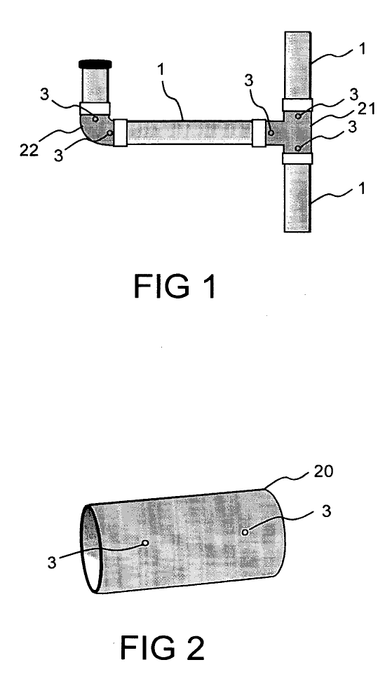

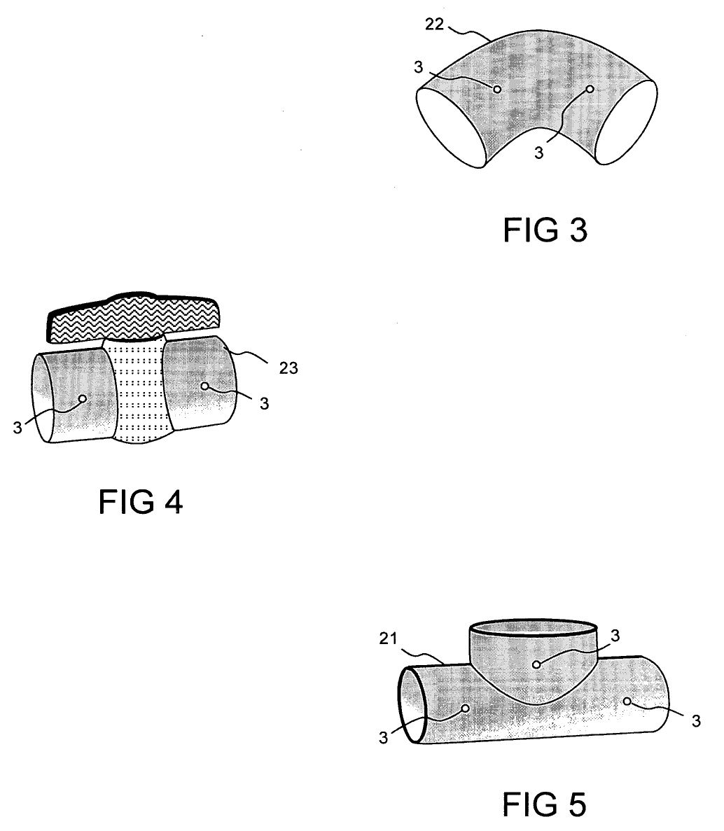

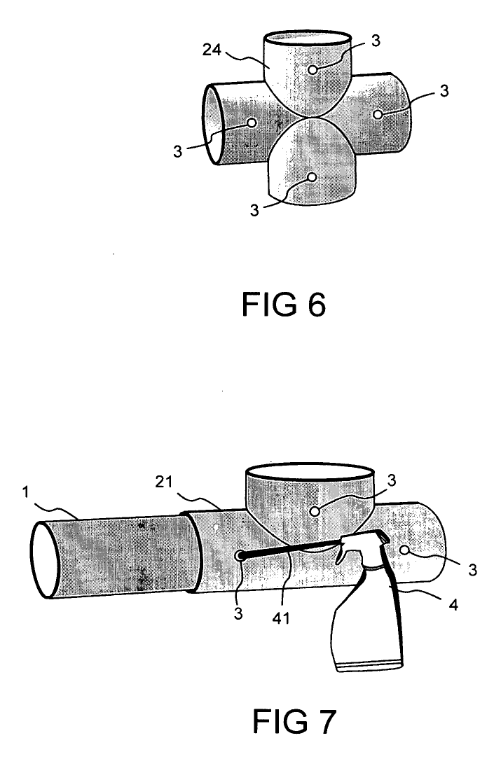

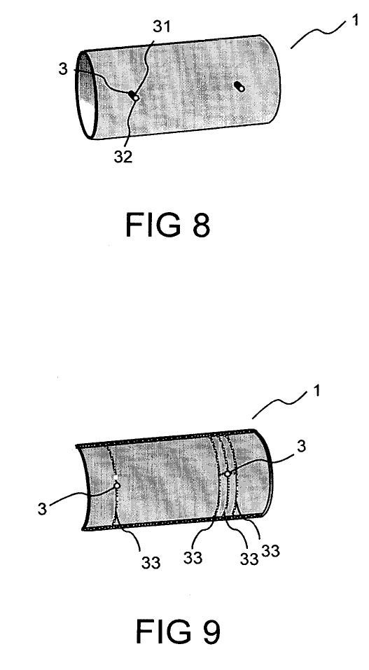

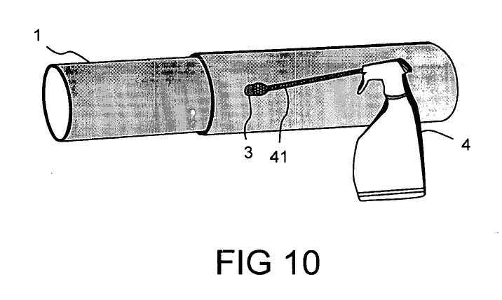

### CROSS REFERENCE TO RELATED APPLICATIONS

This application is a continuation-in-part (CIP) of U.S. patent application Ser. No. 12/001,189, filed Dec. 11, 2007 still pending (Herein after “The Parent Application”); which is incorporated herein by reference.

### TECHNICAL FIELD

The present invention deals with pipelines, pipes and pipeline components used to convey fluids, as well as a method for joining and sealing pipes and pipe segments to each other.

### BACKGROUND ART

As was described in the Parent Application, Most structures throughout the world are equipped with pipe systems or pipelines used to convey fluids, mainly water. Such pipelines are customarily concealed in the structure's walls, floors and ceilings. Pipelines primarily include pipes, as well as components and accessories that make up the entire pipeline, such as couplings, elbows, valves, fittings and other parts and accessories that are used to join pipes and pipeline parts (hereinafter referred to as “pipeline components”).

For many years it was customary to use pipes and pipeline components (such as couplings, elbows, valves, etc.) that were made of metal and were joined to one another by screwing action. In recent years, it has become customary to use pipes and pipeline components that are made of plastic, mainly PVC. Such PVC pipes and pipeline components are joined to one another using an adhesive referred to in professional jargon as “PVC cement”.

When assembling PVC pipelines in structures, and particularly pipelines intended for the conveyance of water in residential homes, pipelines are usually assembled in stages, as follows:

(a) Pipes are cut according to required lengths;

(b) The pipeline is assembled in the wall (open or exposed wall during the construction of the structure or renovation), but without gluing the part of the pipeline to one another;

(c) After verifying correct dimensions of the pipeline, the pipeline is disassembled from the wall in order to prepare it for gluing;

(d) The pipes and pipeline components are glued to each other according to the order of components in the planned pipeline structure. Gluing is executed by applying PVC cement to the internal part of each relevant pipeline component and to the external part of the pipe that is to be glued to the said component (for instance, a coupling or elbow). After applying PVC cement, the end of the pipe is inserted into the said pipeline component, and after the PVC cement dries, the pipeline is glued, joined and sealed.

(e) After gluing of any number of pipeline components, it is customary to glue the end of this group of glued components to the relevant pipe already fixed in the wall, and so on and so forth, until the entire pipeline is assembled and glued in the wall or floor or other designated place.

Pipes and pipeline components, as they currently exist and the method of their assembly and gluing leads to a considerable waste of time. First, the pipeline is assembled in the designated wall twice. Once in order to verify the dimensions, and a second time, after gluing the pipeline, it is re-assembled in the designated wall. Second, after gluing the pipes and pipeline components to each other, the dimensions may change, since the gluing of the pipes to the pipeline connections slightly changes the connection point of the components, and the accumulation of these changes causes the pipeline to deviate from its designated location and from the location it was in during the first assembly prior to gluing.

The invention significantly streamlines and reduces the cost of gluing and assembling the pipeline.

### THE INVENTION

### Numbers in Parentheses Refer to Numbers in Drawing

As was described in the Parent Application, the invention deals with pipelines that include pipes and pipeline components, and presents a method and a means of joining together pipes and pipeline components.

The invention, subject of the present patent application and of the Parent Application, deals with pipes and pipeline components that include bores, as depicted in the drawings attached to the application. Specifically, the invention deals with pipes and pipeline components whereby the side of each such pipe and pipeline component has a bore located at each end. Bores are preferably located 2 to 4 centimeters from each end of the component. Specifically, the bore should be located at about half the distance between the end of the component and its middle point. The desired diameter of the bores is about 1 to 2 mm., although they may be larger or smaller.

The invention deals with coupling (20) type components that include one or more bores (3), preferably at each end of the coupling, as depicted, for instance, in Drawing No. 2.

The invention deals with elbow (22) type components that include one or more bores (3), preferably at each end of the elbow, as depicted, for instance, in Drawing No. 3.

The invention deals with valve (23) type components that include one or more bores (3), preferably at each end of the valve, as depicted, for instance, in Drawing No. 4.

The invention deals with T-connector (21) type components that include one or more bores (3), preferably at each end of the connector, as depicted, for instance, in Drawing No. 5.

The invention deals with cross (24) type components that include one or more bores (3), preferably at each end of the cross, as depicted, for instance, in Drawing No. 6.

The invention refers to pipes that include one or more bores, preferably at each of their ends.

After assembling the pipeline in the designated wall, liquid acetone is injected into the bores, causing adhesion and sealing of the pipes and pipeline components. Thus, the need to disassemble the pipeline, glue it together using PVC cement and re-assemble it in the designated wall is avoided.

Drawing No. 7 depicts, for example, a T-connector (21) with three bores (3), one end of which is joined to a pipe (1). Also depicted is a spraying device (4) used to inject liquid acetone through the straw (41) directly into the left-hand bore (3), thus, effectively, sealing and gluing the pipe (1) to the connector (21).

Drawing No. 1 depicts, for instance, a pipeline composed of three pipes (1) that are connected to the three ends to a T-connector (21) that has three bores (3). The horizontal pipe (1) is connected to an elbow (22) with two bores (3), one at each end.

As mentioned, the present invention (CIP) refers to the Parent Application originally filed regarding pipelines that include pipes and pipeline components, as well as a method and means of joining together such pipes and pipeline components.

As mentioned, the invention deals with pipe components that include one or more bores (3), preferably at each end of the pipeline component (20, 21, 22, 23, 24). As mentioned in the original application, after assembling the pipeline in the designated wall, liquid acetone is injected into the bores (3), causing adhesion and sealing of the pipes and pipeline components.

We wish to add a supplement to the patent application that improves and increases the efficiency of the products, subject of the invention.

The pipeline components and accessories that, as mentioned, include bores (3) at their ends, will also be equipped with a small tubule (31) that is integrally attached to the pipeline accessory and protrudes upward from the bore (3). The tubule (31) is in fact a hollow tube that has a hole (32) at its top, and whose bottom end is connected directly to the bore (3) on the pipeline accessory. Thus, the upper hole (32) serves as a channel and tube through which the adhesive is delivered directly into the inner part of the pipeline accessory, as depicted, for instance, in Drawing No. 8.

The tubule (31) can be attached to the pipeline accessory, for instance, by being cast together with it as a single unit during the manufacturing (casting) of the accessory. Alternately, the tubule (31) can be supplied as a separate unit and be attached to the bore (3) before injection of the adhesive of acetone into the upper hole (32) of the tubule (31).

In addition, the pipeline accessories also include a groove (33) on the inner part of the pipeline accessories, as depicted, for instance, in Drawing No. 9. The groove is in fact engraved along the inner perimeter of the accessory. It is preferable that the groove (33) connect to the bore (3). Thus, when the acetone or adhesive is poured or injected into the bore (3) [or the upper hole (32)] so as to execute the joining, the adhesive or acetone will flow in the groove (33), enabling the adhesive to penetrate along the entire inner perimeter of the accessory, so as to ensure effective joining and complete sealing. Pipeline accessories can include one such groove (33) or several parallel groove that are connected by one or more perpendicular grooves, as depicted in the right-hand part of Drawing No. 9.

In addition, pipes can be joined to the pipeline accessories using acetone, as mentioned in the original application filed, or using other adhesives used for joining pipeline components or plastic components. In order to increase the efficiency of the adhesion and prevent dripping or leakage of adhesive material during injection of the adhesive into the bore (3) or into the upper hole (32), the tubule (41) that delivers the adhesive material from the container (4) into the bore (3) or the upper hole (32) should be ring-shaped so as to seal the entire perimeter of the bore during the injection of adhesive into the bore. In addition, the end of the tubule (41) can be cylindrical so as to fit over the pipe (31) while the adhesive is being injected into the upper hole (32), like, for instance, the way in which vehicle tires are filled with air.

This supplement includes the above-described and detailed Drawings No. 7-9.

### DESCRIPTION OF THE DRAWINGS

The drawings attached to this application (as of as to the Parent Application) are not intended to limit the scope of the invention and the possible ways of its application. The drawings are intended only to illustrate the invention and constitute only one of many possible ways of its application.

The drawings attached to the present patent application are described and detailed above.

What is claimed is:

3. Pipes and pipeline components as mentioned in claim No. 1, including a hollow tubule, whose bottom end is attached to the said bore and its top is directed outward so that the external upper hole of the tubule serves to deliver the adhesive materials into the said bore and from there to the inner perimeter wall of the said accessories.

4. Pipes and pipeline components as mentioned in claim No. 1, including one or more groove along the inner perimeter or the said pipeline accessories adjacent to the said bore so that when the adhesive material is poured into the said bore it reaches the entire inner perimeter of the joined pipeline accessories, in order to ensure effective joining and sealing.

5. A method for joining PVC or plastic pipes and pipeline components designed to be assembled into a pipeline used to convey fluids in structures, as mentioned in claim No. 2, whereby instead of liquid acetone, other adhesive materials are used.
